(19) United States
(12) Patent Application Publication
(10) Pub. No.: US 2014/0238409 A1
(43) Pub. Date: Aug. 28, 2014

(54) Perinatal Care Device

(71) Applicant: Paula O'Brien, Bellingham, WA (US)

(72) Inventor: Paula O'Brien, Bellingham, WA (US)

(21) Appl. No.: 13/799,801

(22) Filed: Mar. 13, 2013

Related U.S. Application Data
(60) Provisional application No. 61/768,767, filed on Feb. 25, 2013.

(51) Int. Cl. A61G 13/12

(52) U.S. Cl. CPC A61G 13/121
USPC 128/845

(57) ABSTRACT

A perinatal care device provides a shield that is placed over the mother's lower thorax. The shield is generally in the shape of a part dome, with its rim extending towards the mother's head. Warm air is delivered to a manifold in or on the shield, from which it is distributed to the space between the shield and the mother's thorax. Thus, a region of warm air can be provided within which the baby and mother are comfortable, and the baby is physically separated by the shield from an continuing surgical activity on the mother's abdomen.

### CROSS REFERENCE. TO RELATED APPLICATIONS

This application claims benefit of U.S. Provisional Patent Application No. 61/768,767, filed Feb. 25, 2013 by O'Brien, the entire contents of which are incorporated in this application by reference as if set forth explicitly herein.

### BACKGROUND

The invention relates to the perinatal care of mothers and babies. A large body of research supports early skin-to-skin contact as a precursor to successful initiation and duration of breastfeeding and improved well-being of the mother-baby dyad. The American Academy of Pediatrics has recommended that “all healthy infants should be placed and remain in skin-to-skin contact with their mothers immediately after delivery until the first feeding occurs” (Gartner, L. & Eidelman, A., Breastfeeding and the use of human milk, Pediatrics, 115, 496-506. Doi:10:1542/peds.2004-2491 (2005), p. 498).

However, in the case of cesarean births, thist presents practical difficulties. First, the Joint Committee on Administration Rules for Obstetric Departments (2012) recommends a temperature of 72-76° F. (22-24° C.) in the delivery suite to maintain a neutral thermal environment for the newborn. Surgical operating, rooms are usually kept at as lower temperature. In the U.S.A., the average operating room temperature is between 68-73° F. (20-23° C.) and sometimes as low as 66-68° F. (19-20° C.), which is undesirably cool for a newborn baby. Second, surgery may continue for a considerable period after the actual delivery of the baby, for example, to repair and close the surgical incision made for the cesarean birth. It may be hazardous to the baby to be exposed too closely to the sharp instruments, hard equipment, rapid activity, and fluids involved in surgery. Third, surgical operating tables are typically narrow, to allow easy access for the surgical personnel, presenting a risk that if the baby slips off the mother it may easily fall to the floor and be harmed. That has in the past required a nurse to be in constant attendance next to the mother if the baby is placed skin to skin with the mother while the mother is still on the operating table.

### SUMMARY

An embodiment of a perinatal care device provides a shield that is placed over the mother's lower thorax. The shield is generally in the shape of a part dome, with its rim extending towards the mothers head. Warm air is delivered to a manifold in or on the shield, from which it is distributed to the space between the shield and the mother's thorax. Thus, a region of warm air can be provided within which the baby and mother are comfortable, and the baby is physically separated by the shield from any continuing surgical activity on the mother's abdomen.

In an embodiment, jets of warm air from the upper rim of the shield are angled obliquely, inwards and towards the mother's head. Thus, the region of warm air can extend headward further than the shield. The shield thus does not need to extend over the mother's head to a point that would cause a feeling of claustrophobia in the average patient,

In an embodiment, the shield is provided with wings or upper segment, extending headward towards the mother's shoulders, and sufficiently high that, if the mother loses her grip on the baby, the baby will be retained by the wings, and does not risk falling off the operating table. In a further embodiment, the wings or upper segment are part of a continuous wall extending round above the mother's head. The ends of the wings are thus connected, increasing the strength and stiffness of the wings with only a small increase in the weight of the device. The wall may extend round a pillow or wedge raising the mother's head, or head and upper torso, so that the wall does not uncomfortably enclose the mother's face.

The device may be constructed with a center section that lies on the operating, table, or on a mattress, under the mother's body, and is held in place largely by the mother's weight, and two side sections that form the shield and (if present) the wings. To form the shield, the two side sections may be folded together over the mother's body and joined in the middle by clips, clasps, snap fasteners, or any other suitable mechanism. The fasteners may be adjustable to fit mothers of different sizes, either by overlapping the side sections in the middle for a smaller mother, or allowing a gap between the fasteners for to larger mother, or both.

The manifold to distribute warm air may be a separate liner that fits inside the shield, and is held in place by allowing it to expand under the pressure of the air in the manifold. The liner can then bridge a gap at the join between two halves of the shield.

The shield may be an inflatable device, supported by the pressure of air in compartments inside it. The shield can then be light in weight, and very compact, for ease of storage and transport, in its uninflated condition. The supporting compartments for the shield may be the air chambers of the warm air manifold, separate chambers connected to the same or a different air supply, or separate chambers that are inflated and then closed off. The shield may be inflated over the patient's body, after it has been positioned and at least partially assembled. The inflatable shield may comprise a framework of inflatable tubes with non-inflatable sheets or membranes filling in the spaces between the tubes.

Various parts of the device may be made reusable, in which case they should be easy to clean and sterilize, or may be made disposable. For example, where the shield and the liner are separate components, the shield may be made reusable, and may be relatively robust, providing the main mechanical strength. The liner with the warm air manifold may cover the inside of the shield, protecting the shield from contamination. The liner may be disposable. The liner can then be of relatively light construction, because it is mechanically supported by the shield when in use.

The perinatal care device may be combined with various other devices. For example, a ramp may be provided to elevate the mother's head and upper torso, which may be beneficial to assist the mother's comfort and breathing. A “left lateral tilt” support may be provided under the right side of the mother's torso. The patient may lie on an inflatable air transfer bed, such as those sold by Airpal. Inc, of Coopersburg, Pa., U.S.A. Any of those other devices may also be inflatable, and may be inflated from the same air supply as the perinatal care device. The various devices may be integrated into a unitary construction, or may be provided with snaps or other attachments to secure them together releasably.

An electrosurgical grounding pad, such as those sold by Megadyne Medical Products, Inc., Draper, Utah, U.S.A may be provided. It has been found experimentally that the electrosurgical grounding pad can be placed under the air transfer bed, provided the air transfer bed is not inflated until electrosurgery has been completed. The mentioned ramp does not interfere with electrosurgery, because the mother's lower torso and legs, which are not elevated by the ramp, can provide sufficient connection with the electrosurgical grounding pad. A commercially available warming pad may be placed under the electrosurgical grounding pad.

### BRIEF DESCRIPTION OF DRAWINGS

The above and other aspects, features, and advantages of the present invention will be more apparent from the following more particular description thereof, presented in conjunction with the following drawings wherein:

FIG. 1 is a side elevation view of an embodiment of an inflatable perinatal care device in an in-use condition.

FIG. 2 is a side elevation view of the device of FIG. 1 in an installed but uninflated condition.

FIG. 3 is a top view of the device of FIG. 1 an uninflated condition.

FIG. 4 is a partially sectional side elevation view of the device of FIG. 1 and associated devices.

FIG. 5 is a plan view an inner liner forming part of the device of FIG. 1.

FIG. 6 is an axial sectional view of an embodiment of an air connector assembly for the device of FIG. 1.

FIG. 7 is a side elevation view of an alternative form of air connector.

FIG. 8 is a detail view of an emergency deflation valve.

### DETAILED DESCRIPTION

A better understanding of various features and advantages of the present methods and devices may be obtained by reference to the following detailed description and accompanying drawings, which set forth illustrative embodiments. Although these drawings depict embodiments of the contemplated methods and devices, they should not he construed as foreclosing alternative or equivalent embodiments apparent to those of ordinary skill in the subject art.

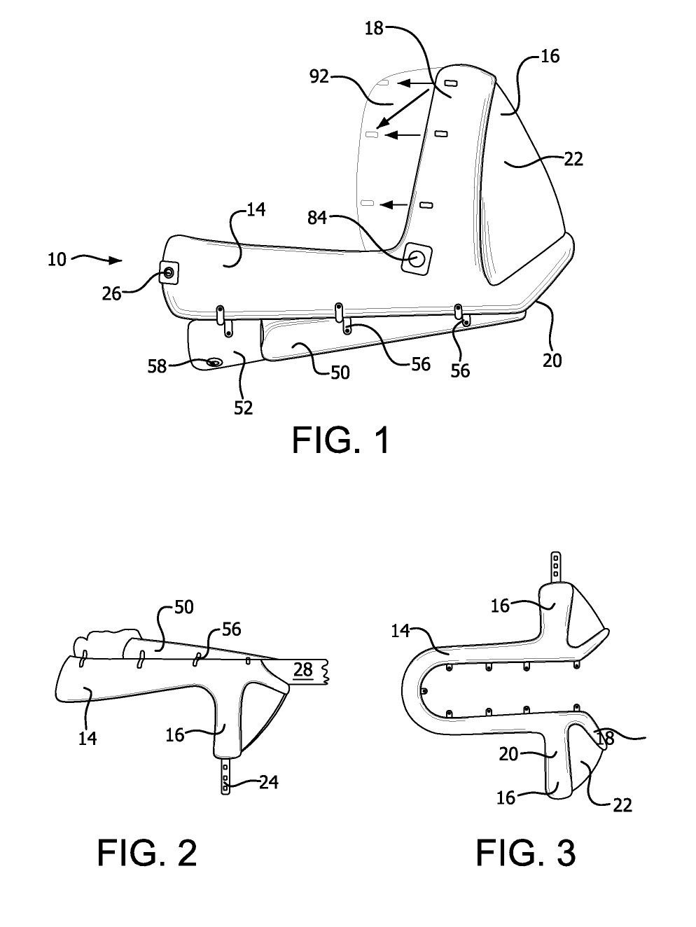

Referring, to the drawings, and initially to FIGS. 1 to 3, one embodiment of a perinatal care device, indicated generally by the reference number 10, comprises a flat base panel 12 that in use lies on the operating table under the upper torso and head of the mother (not shown), a wall portion 14 that encircles the mother's head and shoulders, and two shield portions 16, one attached to either side of the base panel 12. The wall portion 14 is an inflatable tube that can be folded flat when uninflated, but that when inflated rises high enough to retain a baby against sliding, sideways off the mother's thorax.

Each of the shield portions 16 comprises a rim tube 18, a body tube 20, and a membrane panel 22. When the shield is positioned over the mother, the body tubes 20 lie on the mother's upper thorax, meeting in the middle. The rim tubes 18 arch above the mother's sternum, meeting in the middle. Each membrane panel 22 extends between the body tube 20 and the rim tube 18, and the membrane panels meet in the middle. The two shield portions are joined in the middle by snaps, clasps, or other fastenings 24. The body tubes 20 and rim tubes 18 are inflatable, and when they are joined and inflated the shield is self-supporting. The body tubes 20, rim tubes 18, and wall portion 14 may be a single inflatable chamber that can be inflated through an air inlet 26. Alternatively, they may be separate chambers that either are separately inflated through inlets 26, or have internal valves to restrict the flow of air from one chamber to another.

As shown in FIG. 2, when the device 10 is uninflated, it can be hung over the head end of a standard hospital operating table 28, with the base panel 12 lying on the table 28, and the shield portions 16 and wall portion 14 hanging down. The device 10 is then effectively out of the way of the hospital personnel while they are placing and preparing the patient.

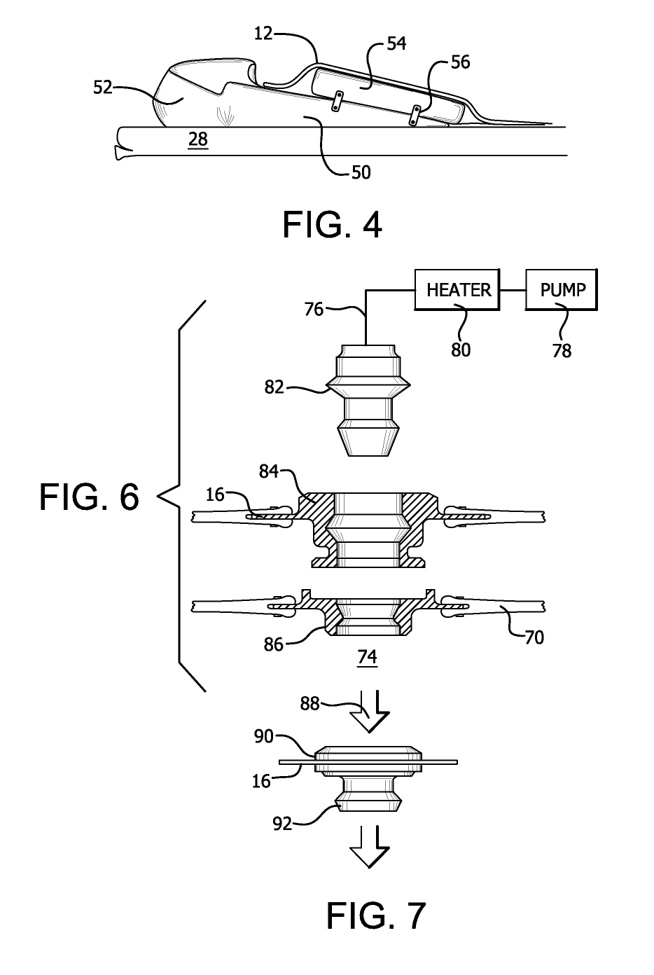

Referring now also to FIG. 4, the perinatal care device 10 may be used in combination with additional devices such as a ramp 50, and/or a pillow 52, and/or a “left lateral tilt” pad 54, which may also be inflatable. A ramp 50 is not preferred for obstetric use, although it may be beneficial for some other purposes. These additional devices 52, 54 may be unitary with the perinatal care device 10 or may be separate components. If they are separate components, the various devices are preferably provided with snaps or other fasteners 56 to hold them together in use, reducing the risk of problems because one device moves relative to another. The pillow 52 and “left lateral tilt” pad 54 may be placed on top of the base panel 12 of the perinatal care device 10, as shown in FIG. 2, or under the base panel 12, as shown in FIG. 1. Where the pillow 52 and/or “left lateral tilt” pad 54 is incorporated with the perinatal care device 10, it is preferably a separately inflatable and deflatable chamber.

As shown in the drawings, the additional devices 50, 52, 54 are inflatable devices provided with separate air inlets 58. If they are unitary with the perinatal care device 10, some or all of the devices may alternatively share a common air supply. Some or all of the additional devices 50, 52, 54 may alternatively be non-inflatable devices. Air to inflate the perinatal care device 10 and any additional devices 50, 52, 54 may be provided by an existing hospital compressed air supply, or by a dedicated pump associated with or included in perinatal care device 10. Because those devices are typically only inflated one for each surgical procedure and are then essentially static, a hand or foot pump may be sufficient, eliminating a hose or cable. However, an electric pump may be preferred in the interests of speed, especially if the perinatal care device 10 is being installed and inflated by a person who has many other responsibilities. The use of a hospital compressed air supply may require regulatory approval if the same air supply is also used for medical purposes.

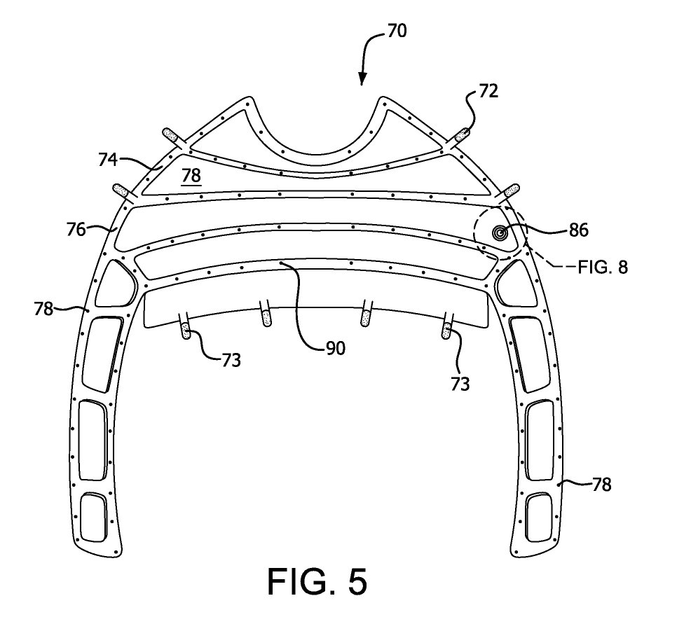

Referring now also to FIG. 5, the perinatal care device 10 includes an inner liner, indicated generally by the reference number 70. The inner liner 70 is placed inside the device after the two shield portions 16 have been joined by the fasteners 24, and is held in place by snaps or other fasteners 72, along the lower edge, near where the base panel meets the wall tubes 14 and body tubes 20, and fasteners 73 along the upper edge, along the rim tubes 18. The inner liner 70 comprises a manifold 74 in the form of a grid of air tubes 76 with membrane panels 78 between them. The air tubes 76 are perforated with air holes 78, allowing air to escape in calibrated amounts flowing in calibrated directions. In use, the manifold 74 is pressurized with warm air, and the air pressure holds the inner liner 70 against the inside of the shield portions 16.

Because the inner liner 70 is supported by the shield portions 16, the inner liner is not required to be very strong mechanically, and may be disposable. However, the inner liner may still be sufficiently strong to bridge a gap between the shield portions 16, allowing the perinatal care device 10 to fit round a mother of larger size than the nominal size of the device.

Referring now also to FIG. 6, the air supply to the manifold 74 may be provided by a hose 76 from a pump 78 through a heater 80. The pump 78 may be part of an existing hospital compressed air supply, or may be a dedicated pump for perinatal care device 10. At the end of the hose 76 is a connector 82, which locks into a port 84 passing through the wall of one shield portion 16 for mechanical security, and into a port 86 that opens into manifold 74. Locking between connector 82 and port 84 is desirable because, as explained above, shield portion 16 is stronger construction than inner liner 70. The risk of the lightly constructed liner 70 being damaged by a force applied to hose 76 is thus reduced. The use of a hospital compressed air supply may reduce noise and clutter in the operating area, but may entail additional regulatory requirements if the same air supply also supports medically sensitive functions elsewhere in the hospital.

Referring to FIG. 7, in an alternative form of air supply, a connector 88 on the hose 76 mates with the port 90 on the shield portion 16, and the port 90 includes a connector 92 that mates with the port 86 on the inner liner.

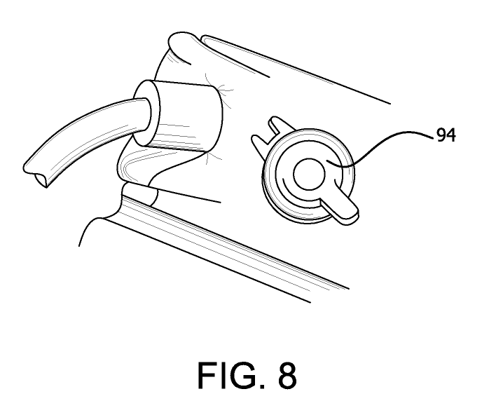

Each separately inflatable chamber of the device 10. including any pillow 52, left lateral tilt device 54, or other additional component, is provided with an emergency deflation valve 94 (see FIG. 8). The emergency deflation valves 94 may be of any suitable design. Their function is to allow all the air from the inflatable chamber to be released so as to deflate the chamber almost immediately if there is a medical need to lower the patient onto the flat, solid surface of the underlying mattress or operating table, or if there is an emergency in which the perinatal care device 10 needs to he removed quickly. A complex structure such as the manifold system of inner liner 70 may be provided with more than one emergency deflation valve 94.

In use, the perinatal care device 10 (not including the inner liner 70) and any desired additional devices 50, 52, 54 are assembled and placed in an uninflated condition over the head end of the operating table 28, as shown in FIG. 2. If the operating table 28, or a cover over the operating table, has suitable attachment points, the perinatal care device 10 may be attached to the table. Any desired warming pads, electrosurgical grounding pads, air cushion patient transfer pads, and other items may also be placed on the operating table at this time. Alternatively, if the patient is being brought in on a patient transfer pad, the perinatal care device 10 and additional devices 50, 52, 54 may be assembled on top of the patient transfer pad.

The mother is then placed on the operating table 28, on top of the base sheet 12 of the perinatal care device 10. The pillow 52 and/or left lateral tilt pad 54 may be inflated at this or any convenient later time, if they have an air inlet or air inlets 58 separate from the perinatal care device 10. Alternatively, the pillow 52 may be inflated before the mother's head is placed on the pillow. The inner liner 70 is then laid loosely over the mother's body, and the fasteners 72 around the outer edge of the inner liner are attached to the device 10.

The shield portions 16 are then folded up over the inner liner 70, and fastened in the middle with the fasteners 24. The inner liner 70 may be attached to the rim tubes 18 of the shield portions 16 by further fasteners 73 at this stage. To ensure a snug but not tight fit of the body tubes 20 around the mother's body, and a suitable height of the shield, the fasteners 24 are preferably adjustable, at least at the body tubes 20. The adjustment may allow an overlap between the shield portions 16 to fit a mother smaller than the nominal size of the perinatal care device 10, and/or a gap between the shield portions 16 to fit a mother larger than the nominal size of the perinatal care device 10. The inner liner 70, supported by the fasteners 24 themselves, can bridge a significant gap. It is presently believed that the fastening of the rim tubes 18 does not need to be adjustable.

The inflatable tubes 14, 18, 20 of the device are then inflated by supplying air through the port 26, to raise the walls 14 and the shield 16 to their desired height. The warm air pump 78 and heater 80 are then started, to supply warm air to the manifold 74 and, through the holes 78, to the space between the shield and the mother's upper torso.

As may be seen from FIGS. 1 and 5, the distribution of warm air can be controlled by the position of the holes 78 in the tubes 76. In particular, by placing holes 78 at different places around the circumference of the tubes 76, the direction of the warm air flow can be controlled. For example, the holes 90 in a tube 76 along the rim of the shield can produce a curtain of warm air, indicated by arrow 92 in FIG. 1, extending to the head end away from the shield 16. Thus, the area over the mother's upper thorax can be kept warm for the baby, without the rim of the shield itself overshadowing the mother's face uncomfortably.

The baby may then be placed in skin-to-skin contact with the mother, with both mother and baby being kept warm by the air from holes 78, 90, even while they are still in the cold operating room. If the mother is unable to maintain a secure grasp of the baby, and the baby starts to slide sideways, the baby is restrained by the walls 14, greatly reducing the risk of the baby falling off onto the floor, and removing the need for continuous supervision by a nurse. If the baby is given to the mother immediately after, for example, a cesarean delivery, the physical barrier formed by the perinatal care device 10 also protects the baby from undesirable contact with hard instruments, fluids, and other hazards involved in continuing surgical activity.

As an example of suitable dimensions, the device 10 may be about 30 inches (75 cm) long, measured from the top of the operating table 28. The side walls 14 may rise to a height of 8 inches (20 cm) above the table 28. The lowest portion of the shield, at the body tubes 20, may be adjustable to be 10, 12, or 14 inches (25, 30, or 35 cm) above the top of the operating table 28, and the top of the shield dome at the rim tubes 18 may be 17 inches (40 to 45 cm) above the operating table at its center. The rim 18 may begin about 11 inches (27.5 cm) from the top of the head in the lengthwise direction along the operating table. The left lateral tilt device 54 may be 4 inches (10 cm) wide and 3½ inches (9 cm) high (around 14 inches (36 cm) in diameter), and 14 to 17 inches (35 to 44 cm) long, starting about 22 inches (55 cm) from the head end of the table. A device 10 with those dimensions would fit most mothers, but it may be desirable to provide larger and smaller sizes as well.

While the invention has been disclosed with reference to certain preferred embodiments, numerous modifications, alterations, and changes to the described embodiments are possible without departing from the sphere and scope of the invention, as defined in the appended claims and equivalents thereof.

For example, the device 10 has been described as a perinatal care device for use in permitting skin-to-skin contact between a newborn baby and his or her mother immediately after a cesarean birth. However, there may be other applications where it is desired to keep the head end of a patient warm and shielded during surgery on the abdomen or lower parts of the patient, and the use of the disclosed devices for such other applications is not excluded.

1. A patient care device comprising:
a shield that is configured to be placed over a patient's lower thorax, wherein the shield in an in-use configuration is generally in the shape of a part dome, with its rim extending towards the patient's head, and wherein a space between the shield and the mother's thorax is then sufficiently large for a newborn baby; and
a manifold that in the in-use condition is in or on the shield and is provided with an inlet for air and air outlets to distribute said air to the space between the shield and the patient's thorax.

2. The device of claim 1, further comprising a device for supplying warm air to said manifold through said inlet.

3. The device of claim 1, wherein said air outlets further comprise outlets at an upper rim of the shield positioned to emit jets of air angled obliquely, inwards and towards the patient's head.

4. The device of claim 1, further comprising wings that in the in-use condition extend from said shield towards the patient's shoulders, and are raised above a surface on which the patient and the device are placed.

5. The device of claim 4, wherein the wings are part of a continuous wall arranged to extend round the patient's head.

6. The device of claim 4, further comprising a ramp operative to raise the patient's head and shoulders above a level of a surface on which a lower part of the patient is lying.

7. The device of claim 6, wherein the wings are arranged to extend above the ramp.

8. The device of claim 1, comprising: a center section that is arranged to lie on a supporting surface under the patient's body; two side sections; and fasteners operative to connect the two side sections in a position folded together over the patient's body to form the shield.

9. The device of claim 8, wherein the fasteners are adjustable to fit patients of different sizes.

10. The device of claim 1, further comprising an inner liner removably positionable inside the shield and comprising said manifold.

11. The device of claim 10, wherein in use said inner liner is held in place inside said shield by allowing it to expand under the pressure of the air in the manifold.

12. The device of claim 1, wherein the shield is an inflatable device, supported by the pressure of an in compartments inside it in the in-use condition.
